(19) United States
(12) Patent Application Publication
(10) Pub. No.: US 2008/0298927 A1
(43) Pub. Date: Dec. 4, 2008

(54) POSITIONING PIN

(75) Inventors: ZHENG-HUA CHEN, Shenzhen (CN); JIN-TAO YAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/947,084

(22) Filed: Nov. 29, 2007

(30) Foreign Application Priority Data
Jun. 1, 2007 (CN) 200710074698.1

(51) Int. Cl. F16B 19/02; F16B 1/00

(52) U.S. Cl. 411/495; 411/510

(57) ABSTRACT

A positioning pin (40) is provided. The positioning pin includes a positioning shaft (42) and a flange (41). The flange is formed on one end of the positioning shaft. The positioning portion is formed on the other end of the positioning shaft.

### BACKGROUND OF THE INVENTION

1. Field of the Invention

The present invention relates to positioning pins and, particularly, relates to a positioning pin used in insert molding technology.

2. Description of Related Art

Insert molding technology is increasingly and widely used in manufacturing process of portable electronic devices (e.g., mobile phones, personal digital assistances). For example, a metallic shell is provided. The metallic shell has at least one plastic portion formed via insert molding thereon. In process of the present insert molding, the metallic shell is typically positioned by a positioning pin.

Referring to FIG. 1, a typical positioning pin 10 is used in the step of positioning a workpiece 20 (e.g., a metallic shell). The positioning pin 10 includes an end portion 11 and a connecting portion 12. Referring further to FIG. 2, in the step of positioning the workpiece 20, the workpiece 20 is placed with a mold 30. The positioning pin 10 is aligned with a positioning hole (not labeled) of the workpiece 20 and is then inserted through a combination of the mold 30 and the positioning hole. Thus, the workpiece 20 is positioned with the mold 30 via the positioning pin 10. As such, the end portion 11 resists a surface of the mold 30. The connecting portion 12 engages into the combination of the mold 30 and the workpiece 20 with one end exposed outside thereof.

However, in a process of matching mold 30, the workpiece 20 tends to move relatively to the positioning pin 10 and due to a high speed of the matching process, it is possible for the workpiece 20 to release from the positioning pin 10 and then fall away from the mold 30. The mold 30 used in the insert molding process may be damaged.

What is needed, therefore, is a positioning pin that can overcome the above-mentioned shortcomings.

### SUMMARY

In one aspect, a positioning pin is provided. The positioning pin includes a positioning shaft and a flange. The flange is formed on one end of the positioning shaft. The positioning portion is formed on the other end of the positioning shaft.

In another aspect, a positioning pin is provided. The positioning pin includes a positioning shaft and a flange. The flange is formed on the positioning shaft and configured to resist a surface of the mold. The positioning portion is formed on the positioning shaft and configured to engage with the workpiece in such a manner that the workpiece cannot move relatively to the positioning shaft.

Other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of a positioning pin can be better understood with reference to the following drawings. These drawings are not necessarily drawn to scale, the emphasis instead being placed upon clearly illustrating the principles of the present positioning pin. Moreover, in the drawings like reference numerals designate corresponding parts throughout the several views. Wherever possible, the same reference numbers are used throughout the drawings to refer to the same or like elements of an embodiment.

FIG. 1 is an isometric view of a positioning pin in accordance with a related art;

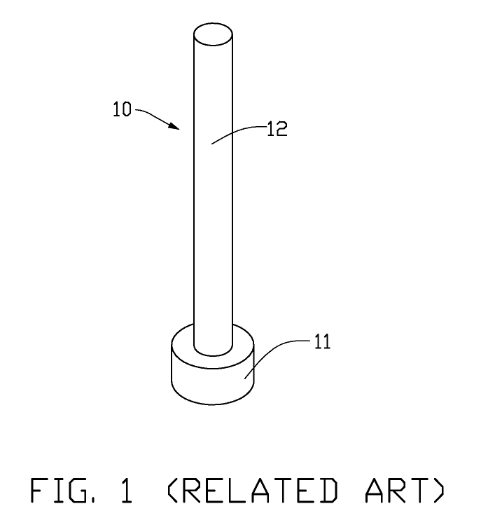

FIG. 2 is an assembled, cut-away view of a combination of the positioning pin shown in FIG. 1, a mold, and a workpiece;

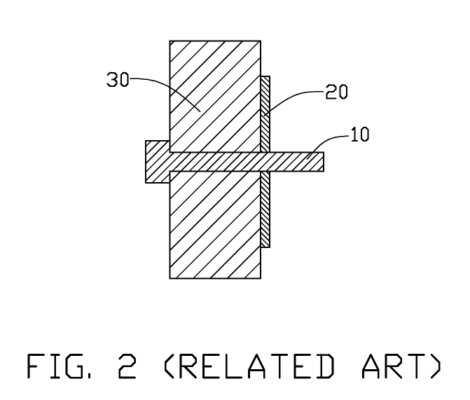

FIG. 3 is an isometric view of a positioning pin in accordance with a present embodiment; and

FIG. 4 is an assembled, cut-away view of a combination of the positioning pin shown in FIG. 3, a mold, and a workpiece.

### DETAILED DESCRIPTION OF PREFERRED EMBODIMENTS

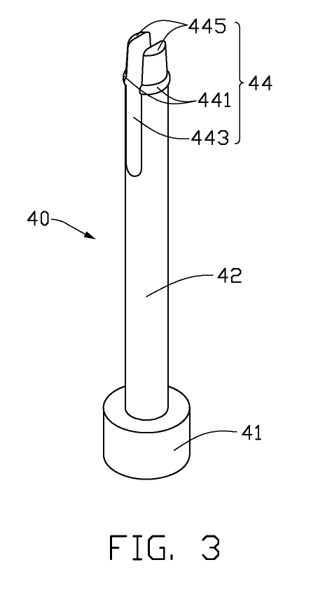

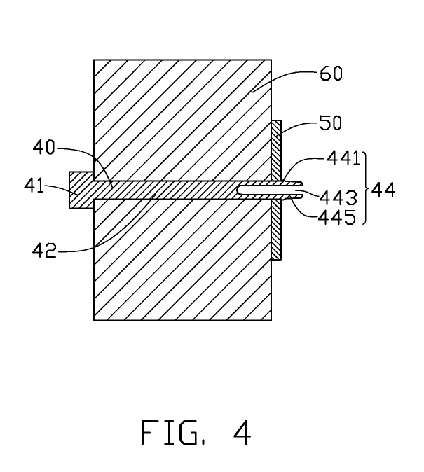

The present positioning pin is described here in conjunction with the accompanying drawings in FIGS. 3 and 4. The positioning pin can be used in many fields, particularly, in insert molding technology. The present positioning pin is exemplified to position a workpiece (e.g., a metallic shell) with a mold during the process of insert molding. It is to be understood that the workpiece can be any part of a portable electronic device (e.g., a mobile phone, a personal digital assistants, or the like) or others that need to be insert molded.

Referring now to FIG. 3, the positioning pin 40 includes a flange 41 and a positioning shaft 42. The flange 41 and the positioning shaft 42 are generally cylindrical-shaped. The positioning shaft 42 is protruded from one end of the flange 41 and is located at the middle of the surface. The positioning shaft 42 has a smaller diameter than that of the flange 41.

The positioning shaft 42 has a positioning portion 44 defined on one end thereof. The positioning portion 44 includes a grippable portion 441, a through slot 443, and two elastic portions 445. The grippable portion 441 is generally a circular ring, which is formed around the exterior surface of the positioning shaft 42. Furthermore, the grippable portion 441 is divided into two sections and spaced by the through slot 443. The grippable portion 441 smoothly connects the exterior surface of the positioning shaft 42, which facilitates the positioning shaft 42 to easily engage into an engaging hole (not labeled in FIG. 4) defined through the workpiece 50.

The through slot 443 is defined through one end of the positioning shaft 42 and an end surface of the end of the positioning shaft 42 (i.e., parallel to an upper surface of the flange 41 and distal thereto). In other words, the end of the positioning shaft 42 is slot-defined by the through slot 443. The remaining end portions are the two elastic portions 445. Each elastic portion 445 is configured (e.g., arranged/structured) with a respective part of the grippable portion 441.

Referring further to FIG. 4, in assembly of the positioning pin 40, a mold 60, and the workpiece 50, the positioning pin 40 is inserted through a positioning hole (not labeled) of the mold 60 as the flange 41 of the positioning pin 40 resists one side surface of the mold 60. In this case, the positioning shaft 42 of the positioning pin 40 is typically accommodated in the positioning hole of the mold 60 and partially exposed outside. Essentially, the grippable portion 441 and the elastic portions 445 of the positioning pin 40 are usefully exposed outwardly from the mold 60. Positioning hole of the workpiece 50 is aligned with the positioning portion 44.

Then, the workpiece 50 is coiled around the positioning portion 44. During this stage, the workpiece 50 is pressingly coiled around the elastic portions 445 and presses against the grippable portion 441. When the workpiece 50 passes over the grippable portion 441, the initially pressed elastic portions 445 are restored to original state. At this time, the workpiece 50 is positioned between one side surface of the mold 60 and the grippable portion 441. The grippable portion 441 helps prevent the workpiece 50 from moving relatively to the positioning shaft 42, and from falling away from the positioning pin 40. Thus, prevent the mold 60 from being damaged due to the risk of the workpiece 50 falling from the mold 60 in molding.

In further alternative embodiments, the grippable portion 441 of the positioning pin 40 contains a plurality of salient points. The salient points can be arranged/distributed around the positioning shaft 42 of the positioning pin 40 and respectively spaced with a particular distance. The grippable portion 441 can instead be a structure that is configured around the positioning shaft 42 in such manner that the grippable portion 441 helps prevent the workpiece 50 from moving relative to the positioning pin 40.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A positioning pin, comprising:
a positioning shaft;
a flange formed on one end of the positioning shaft; and
a positioning portion extending from the other end of the positioning shaft.

2. The positioning pin as claimed in claim 1, wherein the positioning portion comprises a grippable portion, a through slot, and two elastic portions, the grippable portion is formed on the elastic portions, and the two elastic portions cooperatively define the through slot.

3. The positioning pin as claimed in claim 2, wherein the through slot is defined through the positioning shaft.

4. The positioning pin as claimed in claim 2, wherein the grippable portion is a ring, which is formed around exterior surface of the elastic portions and is divided into two essentially same parts and spaced by the through slot.

5. The positioning pin as claimed in claim 4, wherein the grippable portion smoothly connects the exterior surface of the positioning shaft.

6. A positioning pin for use of positioning a workpiece with a mold, comprising:
a positioning shaft;
a flange formed on the positioning shaft and configured to resist a surface of a mold; and
a positioning portion extending from the positioning shaft and configured to engage with a workpiece in such a manner that the workpiece cannot move relative to the positioning shaft.

7. The positioning pin as claimed in claim 6, wherein the positioning portion comprises a grippable portion, a through slot, and two elastic portions, and the grippable portion is formed on the elastic portions, and the two elastic portions cooperatively define the through slot.

8. The positioning pin as claimed in claim 7, wherein the through slot is defined through the positioning shaft.

9. The positioning pin as claimed in claim 7, wherein the grippable portion is a ring, which is formed around exterior surface of the positioning shaft and is broken two essentially same parts and spaced by the through slot.

10. The positioning pin as claimed in claim 9, wherein the grippable portion smoothly connects the exterior surface of the positioning shaft.

11. The positioning pin as claimed in claim 7, wherein the grippable portion comprises a plurality of salient points.
